(19) United States
(12) Patent Application Publication
(10) Pub. No.: US 2023/0163984 A1
(43) Pub. Date: May 25, 2023

(54) USER EQUIPMENT (UE) ROUTE SELECTION POLICY (USRP) UE IN AN EVOLVED PACKET SYSTEM (EPS)

(71) Applicant: Intel Corporation, Santa Clara, CA (US)

(72) Inventor: Changhong Shan, Shanghai (CN)

(21) Appl. No.: 18/095,170

(22) Filed: Jan. 10, 2023

(30) Foreign Application Priority Data
Jan. 13, 2022 (WO) PCT/CN2022/071781

(51) Int. Cl. H04L 12/14

(52) U.S. Cl. CPC H04L 12/1407; H04L 12/1425

(57) ABSTRACT

Systems, apparatuses, methods, and computer-readable media are provided for provisioning an updated user equipment (UE) route selection policy URSP to a UE in an evolved packet system (EPS). In order to minimize the impact to a mobility management entity (MME), some embodiments use a protocol configuration option (PCO) or extended PCO (ePCO) to carry the URSP between a packet data network (PDN) gateway-control (PGW-C) and the UE. Other embodiments may be described and/or claimed.

### CROSS REFERENCE TO RELATED APPLICATION

The present application claims priority to International Patent Application No. PCT/CN2022/071781, which was filed Jan. 13, 2022; the disclosure of which is hereby incorporated by reference.

### FIELD

Various embodiments generally may relate to the field of wireless communications. For example, some embodiments may relate to provisioning the user equipment (UE) route selection policy (USRP) in an evolved packet system (EPS). Specifically, embodiments may relate to provisioning the USRP to a UE when interworking with a fifth generation (5G) system (5GS).

### BACKGROUND

Various embodiments generally may relate to the field of wireless communications.

### BRIEF DESCRIPTION OF THE DRAWINGS

FIG. 1 depicts an example non-roaming interworking architecture, in accordance with varius embodiments.

FIG. 2 illustrates a network, in accordance with various embodiments.

FIG. 3 schematically illustrates a wireless network, in accordance with various embodiments.

FIG. 4 is a block diagram illustrating components, according to some example embodiments, able to read instructions from a machine-readable or computer-readable medium (e.g., a non-transitory machine-readable storage medium) and perform any one or more of the methodologies discussed herein.

FIG. 5 depicts an alternative example network, in accordance with various embodiments.

FIG. 6 depicts an example procedure for practicing the various embodiments discussed herein.

FIG. 7 depicts an alternative example procedure for practicing the various embodiments discussed herein.

FIG. 8 depicts an alternative example procedure for practicing the various embodiments discussed herein.

FIG. 9 depicts an alternative example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

In the interworking scenario between the evolved packet system (EPS) and the fifth generation (5G) system (5GS), a user equipment (UE) may first register to the 5GS and be provisioned with a UE route selection policy (URSP) in 5GS. If the UE then moves to an EPS, some Route Selection component (e.g., data network name (DNN) Selection) in the URSP rule may be used by the UE to derive the access point nam.e (APN) in EPS.

In the legacy design of EPS, if the URSP is subsequently changed, there may not be a way to update the URSP in the UE unless the UE moves back to 5GS. As a consequence, the UE may use the outdated URSP to derive the wrong DNN and APN.

Embodiments herein may relate to the third generation partnership project (3GPP) release-18 (Rel-18) SID FS_eUEPO, which may relate to resolving the above issue. Specifically, embodiments may provide a solution to provision the latest URSP to a UE in EPS. In order to minimize the impact to the mobility management entity (MME), an extended protocol configuration option (ePCO) may be used to carry the URSP between the packet data network (PDN) gateway control (PGW-C) and the UE.

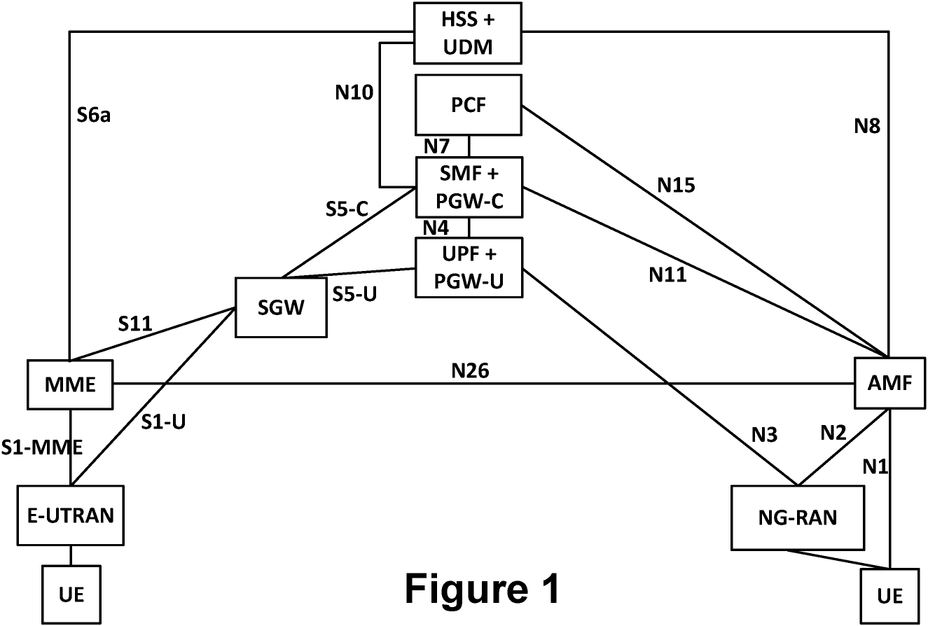

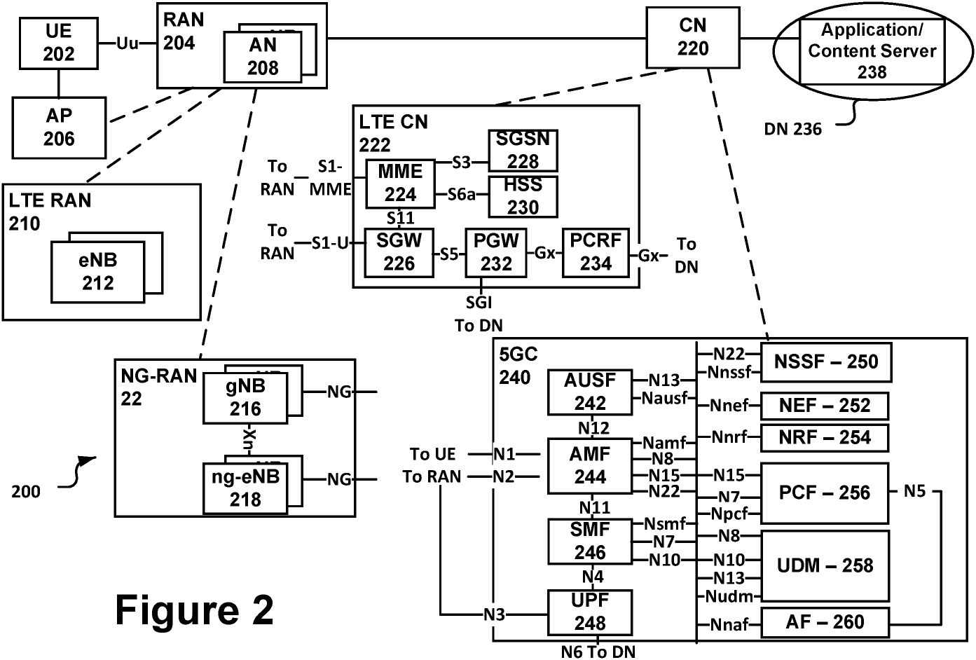

In order to support the non-session management functionality (as may be defined, for example, in clause 6.2.1.1.2 of the third generation partnership project (3GPP) technical specification (TS) 23.503) for a UE-policy and charging function (PCF), the PCF (e.g., as shown in FIGS. 1, 2, or 5), PGW-C (e.g., as shown in FIG. 1), and/or the policy and charging rules function (PCRF) (e.g., as shown in FIG. 2) may need to be enhanced with following functionality:
UE policy information control (as described in clause 6.1.2.2 of TS 23.503).

The 3GPP specifications, and particularly 3GPP TS 23.503 or some other TS, may be updated. Specifically, UE Policy may be defined in TS 23.503. The updates may be as follows:

### 6.1.1 UE Triggered UE Policy Provisioning Procedure

1. The UE reports the UE Policy Container including the PSIs (Policy Set Identifier) and UE Policy (i.e. URSP, ANDSP) Support/Request indication in PCO (Protocol Configuration Option) or ePCO (extended PCO) to PDN GW during Initial Attach procedure (in the Attach Request) as described in clause 5.3.2.1 of TS 23.401 and UE requested PDN connectivity procedure (PDN Connectivity Request) as described in clause 5.10.2 of TS 23.401.

2. When the PGW-C receives the UE Policy Container, it establishes UE Policy Association with PCF or PCRF and forwards the UE Policy Container to PCF or PCRF. If a UE Policy Container is not received from UE, the PGW-C may establish UE Policy Association with PCF or PCRF based on PGW-C local configuration.

3. The PCF or PCRF gets policy subscription related information and the latest list of PSIs from the UDR. The PCF or PCRF creates the UE policy container including UE policy information as defined in clause 6.6 of TS 23.503. Then it sends the latest UE policy information in the UE Policy Container to PGW-C.

4. The PGW-C sends the UE Policy Container in PCO or ePCO to UE in Attach Accept or PDN Connectivity Accept.

### 6.1.2 PCF or PCRF Triggered UE Policy Provisioning Procedure

1. When the PCF or PCRF recognizes the UE Policy is updated, it triggers the UE Policy update procedure towards the PGW-C.

2. The PGW-C provides the updated UE Policy to UE in UE Policy Container via PCO or ePCO, this can be achieved by using new message or reusing existing message (e.g. Update Bear Request) as defined in clause 5.4.3 of TS 23.401.

3. When the UE receives the updated UE Policy, it enforces the update UE Policy and sends a response to PGW-C on acknowledging the reception of the UE Policy.

4. the PGW-C forwards the ACK of UE reception of the UE Policy to PCF or PCRF.

In the deployment, the PCRF or PCF may be collocated in PGW-C, thus the interaction between PGW-C and PCF/PCRF may not be needed for the procedures in clause 6.1.1 and 6.1.2.

### Systems and Implementations

FIGS. 2-4 illustrate various systems, devices, and components that may implement aspects of disclosed embodiments.

FIG. 2 illustrates a network 200 in accordance with various embodiments. The network 200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 200 may include a UE 202, which may include any mobile or non-mobile computing device designed to communicate with a RAN 204 via an over-the-air connection. The UE 202 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 202 may additionally communicate with an AP 206 via an over-the-air connection. The AP 206 may manage a WLAN connection, which may serve to offload some/all network traffic from the RAN 204. The connection between the UE 202 and the AP 206 may be consistent with any IEEE 802.11 protocol, wherein the AP 206 could be a wireless fidelity (Wi-Fi®) router. In some embodiments, the UE 202, RAN 204, and AP 206 may utilize cellular-WLAN aggregation (for example, LWA/LWIP). Cellular-WLAN aggregation may involve the UE 202 being configured by the RAN 204 to utilize both cellular radio resources and WLAN resources.

The RAN 204 may include one or more access nodes, for example, AN 208. AN 208 may terminate air-interface protocols for the UE 202 by providing access stratum protocols including RRC, PDCP, RLC, MAC, and L1 protocols. In this manner, the AN 208 may enable data/voice connectivity between CN 220 and the UE 202. In some embodiments, the AN 208 may be implemented in a discrete device or as one or more software entities running on server computers as part of, for example, a virtual network, which may be referred to as a CRAN or virtual baseband unit pool. The AN 208 be referred to as a BS, gNB, RAN node, eNB, ng-eNB, NodeB, RSU, TRxP, TRP, etc. The AN 208 may be a macrocell base station or a low power base station for providing femtocells, picocells or other like cells having smaller coverage areas, smaller user capacity, or higher bandwidth compared to macrocells.

In embodiments in which the RAN 204 includes a plurality of ANs, they may be coupled with one another via an X2 interface (if the RAN 204 is an LTE RAN) or an Xn interface (if the RAN 204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 204 may each manage one or more cells, cell groups, component carriers, etc. to provide the UE 202 with an air interface for network access. The UE 202 may be simultaneously connected with a plurality of cells provided by the same or different ANs of the RAN 204. For example, the UE 202 and RAN 204 may use carrier aggregation to allow the UE 202 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 204 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 202 or AN 208 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 204 may be an LTE RAN 210 with eNBs, for example, eNB 212. The LTE RAN 210 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 204 may be an NG-RAN 214 with gNBs, for example, gNB 216, or ng-eNBs, for example, ng-eNB 218. The gNB 216 may connect with SG-enabled UEs using a 5G NR interface. The gNB 216 may connect with a 5G core through an NG interface, which may include an N2 interface or an N3 interface. The ng-eNB 218 may also connect with the 5G core through an NG interface, but may connect with a UE via an LTE air interface. The gNB 216 and the ng-eNB 218 may connect with each other over an Xn interface.

In some embodiments, the NG interface may be split into two parts, an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN214 and an AMF 244 (e.g., N2 interface).

The NG-RAN 214 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 202 can be configured with multiple BWPs where each BWP configuration has a different SCS. When a BWP change is indicated to the UE 202, the SCS of the transmission is changed as well. Another use case example of BWP is related to power saving. In particular, multiple BWPs can be configured for the UE 202 with different amount of frequency resources (for example, PRBs) to support data transmission under different traffic loading scenarios. A BWP containing a smaller number of PRBs can be used for data transmission with small traffic load while allowing power saving at the UE 202 and in some cases at the gNB 216. A BWP containing a larger number of PRBs can be used for scenarios with higher traffic load.

The RAN 204 is communicatively coupled to CN 220 that includes network elements to provide various functions to support data and telecommunications services to customers/subscribers (for example, users of UE 202). The components of the CN 220 may be implemented in one physical node or separate physical nodes. In some embodiments, NFV may be utilized to virtualize any or all of the functions provided by the network elements of the CN 220 onto physical compute/storage resources in servers, switches, etc. A logical instantiation of the CN 220 may be referred to as a network slice, and a logical instantiation of a portion of the CN 220 may be referred to as a network sub-slice.

In some embodiments, the CN 220 may be an LTE CN 222, which may also be referred to as an EPC. The LTE CN 222 may include MME 224, SGW 226, SGSN 228, HSS 230, PGW 232, and PCRF 234 coupled with one another over interfaces (or “reference points”) as shown. Functions of the elements of the LTE CN 222 may be briefly introduced as follows.

The MME 224 may implement mobility management functions to track a current location of the UE 202 to facilitate paging, bearer activation/deactivation, handovers, gateway selection, authentication, etc.

The SGW 226 may terminate an S1 interface toward the RAN and route data packets between the RAN and the LTE CN 222. The SGW 226 may be a local mobility anchor point for inter-RAN node handovers and also may provide an anchor for inter-3GPP mobility. Other responsibilities may include lawful intercept, charging, and some policy enforcement.

The SGSN 228 may track a location of the UE 202 and perform security functions and access control. In addition, the SGSN 228 may perform inter-EPC node signaling for mobility between different RAT networks; PDN and S-GW selection as specified by MME 224; MME selection for handovers; etc. The S3 reference point between the MME 224 and the SGSN 228 may enable user and bearer information exchange for inter-3GPP access network mobility in idle/active states.

The HSS 230 may include a database for network users, including subscription-related information to support the network entities’ handling of communication sessions. The HSS 230 can provide support for routing/roaming, authentication, authorization, naming/addressing resolution, location dependencies, etc. An S6a reference point between the HSS 230 and the MME 224 may enable transfer of subscription and authentication data for authenticating/authorizing user access to the LTE CN 220.

The PGW 232 may terminate an SGi interface toward a data network (DN) 236 that may include an application/content server 238. The PGW 232 may route data packets between the LTE CN 222 and the data network 236. The PGW 232 may be coupled with the SGW 226 by an S5 reference point to facilitate user plane tunneling and tunnel management. The PGW 232 may further include a node for policy enforcement and charging data collection (for example, PCEF). Additionally, the SGi reference point between the PGW 232 and the data network 236 may be an operator external public, a private PDN, or an intra-operator packet data network, for example, for provision of IMS services. The PGW 232 may be coupled with a PCRF 234 via a Gx reference point.

The PCRF 234 is the policy and charging control element of the LTE CN 222. The PCRF 234 may be communicatively coupled to the app/content server 238 to determine appropriate QoS and charging parameters for service flows. The PCRF 232 may provision associated rules into a PCEF (via Gx reference point) with appropriate TFT and QCI.

In some embodiments, the CN 220 may be a 5GC 240. The 5GC 240 may include an AUSF 242, AMF 244, SMF 246, UPF 248, NSSF 250, NEF 252, NRF 254, PCF 256, UDM 258, and AF 260 coupled with one another over interfaces (or “reference points”) as shown. Functions of the elements of the 5GC 240 may be briefly introduced as follows.

The AUSF 242 may store data for authentication of UE 202 and handle authentication-related functionality. The AUSF 242 may facilitate a common authentication framework for various access types. In addition to communicating with other elements of the 5GC 240 over reference points as shown, the AUSF 242 may exhibit an Nausf service-based interface.

The AMF 244 may allow other functions of the 5GC 240 to communicate with the UE 202 and the RAN 204 and to subscribe to notifications about mobility events with respect to the UE 202. The AMF 244 may be responsible for registration management (for example, for registering UE 202), connection management, reachability management, mobility management, lawful interception of AMF-related events, and access authentication and authorization. The AMF 244 may provide transport for SM messages between the UE 202 and the SMF 246, and act as a transparent proxy for routing SM messages. AMF 244 may also provide transport for SMS messages between UE 202 and an SMSF. AMF 244 may interact with the AUSF 242 and the UE 202 to perform various security anchor and context management functions. Furthermore, AMF 244 may be a termination point of a RAN CP interface, which may include or be an N2 reference point between the RAN 204 and the AMF 244; and the AMF 244 may be a termination point of NAS (N1) signaling, and perform NAS ciphering and integrity protection. AMF 244 may also support NAS signaling with the UE 202 over an N3 IWF interface.

The SMF 246 may be responsible for SM (for example, session establishment, tunnel management between UPF 248 and AN 208); UE IP address allocation and management (including optional authorization); selection and control of UP function; configuring traffic steering at UPF 248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 244 over N2 to AN 208; and determining SSC mode of a session. SM may refer to management of a PDU session, and a PDU session or “session” may refer to a PDU connectivity service that provides or enables the exchange of PDUs between the UE 202 and the data network 236.

The UPF 248 may act as an anchor point for intra-RAT and inter-RAT mobility, an external PDU session point of interconnect to data network 236, and a branching point to support multi-homed PDU session. The UPF 248 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 248 may include an uplink classifier to support routing traffic flows to a data network.

The NSSF 250 may select a set of network slice instances serving the UE 202. The NSSF 250 may also determine allowed NSSAI and the mapping to the subscribed S-NSSAIs, if needed. The NSSF 250 may also determine the AMF set to be used to serve the UE 202, or a list of candidate AMFs based on a suitable configuration and possibly by querying the NRF 254. The selection of a set of network slice instances for the UE 202 may be triggered by the AMF 244 with which the UE 202 is registered by interacting with the NSSF 250, which may lead to a change of AMF. The NSSF 250 may interact with the AMF 244 via an N22 reference point; and may communicate with another NSSF in a visited network via an N31 reference point (not shown). Additionally, the NSSF 250 may exhibit an Nnssf service-based interface.

The NEF 252 may securely expose services and capabilities provided by 3GPP network functions for third party, internal exposure/re-exposure, AFs (e.g., AF 260), edge computing or fog computing systems, etc. In such embodiments, the NEF 252 may authenticate, authorize, or throttle the AFs. NEF 252 may also translate information exchanged with the AF 260 and information exchanged with internal network functions. For example, the NEF 252 may translate between an AF-Service-Identifier and an internal 5GC information. NEF 252 may also receive information from other NFs based on exposed capabilities of other NFs. This information may be stored at the NEF 252 as structured data, or at a data storage NF using standardized interfaces. The stored information can then be re-exposed by the NEF 252 to other NFs and AFs, or used for other purposes such as analytics. Additionally, the NEF 252 may exhibit an Nnef service-based interface.

The NRF 254 may support service discovery functions, receive NF discovery requests from NF instances, and provide the information of the discovered NF instances to the NF instances. NRF 254 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 254 may exhibit the Nnrf service-based interface.

The PCF 256 may provide policy rules to control plane functions to enforce them, and may also support unified policy framework to govern network behavior. The PCF 256 may also implement a front end to access subscription information relevant for policy decisions in a UDR of the UDM 258. In addition to communicating with functions over reference points as shown, the PCF 256 exhibit an Npcf service-based interface.

The UDM 258 may handle subscription-related information to support the network entities’ handling of communication sessions, and may store subscription data of UE 202. For example, subscription data may be communicated via an N8 reference point between the UDM 258 and the AMF 244. The UDM 258 may include two parts, an application front end and a UDR. The UDR may store subscription data and policy data for the UDM 258 and the PCF 256, and/or structured data for exposure and application data (including PFDs for application detection, application request information for multiple UEs 202) for the NEF 252. The Nudr service-based interface may be exhibited by the UDR 221 to allow the UDM 258, PCF 256, and NEF 252 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 258 may exhibit the Nudm service-based interface.

The AF 260 may provide application influence on traffic routing, provide access to NEF, and interact with the policy framework for policy control.

In some embodiments, the 5GC 240 may enable edge computing by selecting operator/3rd party services to be geographically close to a point that the UE 202 is attached to the network. This may reduce latency and load on the network. To provide edge-computing implementations, the 5GC 240 may select a UPF 248 close to the UE 202 and execute traffic steering from the UPF 248 to data network 236 via the N6 interface. This may be based on the UE subscription data, UE location, and information provided by the AF 260. In this way, the AF 260 may influence UPF (re)selection and traffic routing. Based on operator deployment, when AF 260 is considered to be a trusted entity, the network operator may permit AF 260 to interact directly with relevant NFs. Additionally, the AF 260 may exhibit an Naf service-based interface.

The data network 236 may represent various network operator services, Internet access, or third party services that may be provided by one or more servers including, for example, application/content server 238.

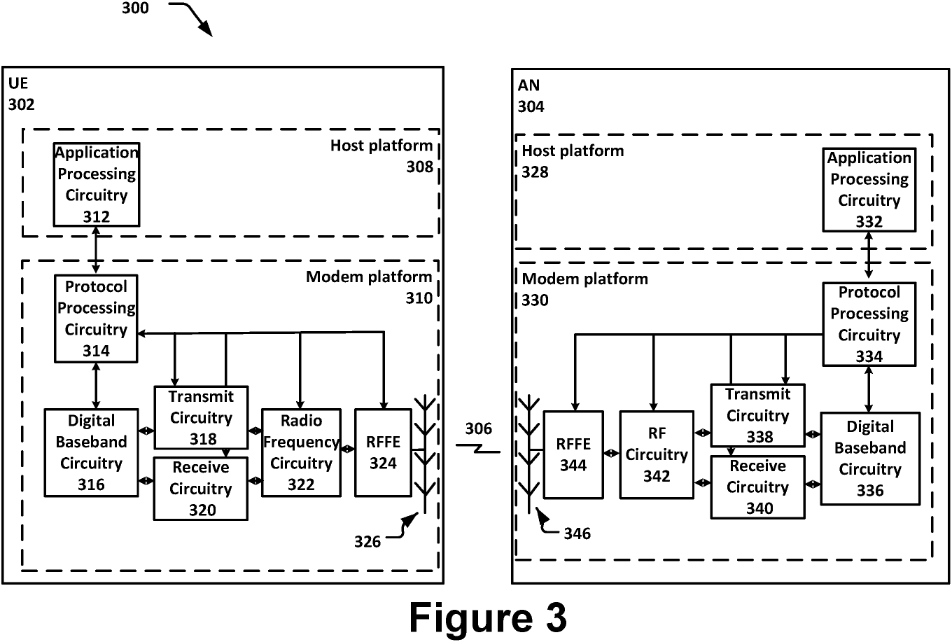

FIG. 3 schematically illustrates a wireless network 300 in accordance with various embodiments. The wireless network 300 may include a UE 302 in wireless communication with an AN 304. The UE 302 and AN 304 may be similar to, and substantially interchangeable with, like-named components described elsewhere herein.

The UE 302 may be communicatively coupled with the AN 304 via connection 306. The connection 306 is illustrated as an air interface to enable communicative coupling, and can be consistent with cellular communications protocols such as an LTE protocol or a 5G NR protocol operating at mmWave or sub-6GHz frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example UDP) and Internet (for example, IP) operations

The protocol processing circuitry 314 may implement one or more of layer operations to facilitate transmission or reception of data over the connection 306. The layer operations implemented by the protocol processing circuitry 314 may include, for example, MAC, RLC, PDCP, RRC and NAS operations.

The modem platform 310 may further include digital baseband circuitry 316 that may implement one or more layer operations that are “below” layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, mixer, intermediate frequency (IF) components, etc.; the receive circuitry 320 may include an analog-to-digital converter, mixer, IF components, etc.; the RF circuitry 322 may include a low-noise amplifier, a power amplifier, power tracking components, etc.; RFFE 324 may include filters (for example, surface/bulk acoustic wave filters), switches, antenna tuners, beamforming components (for example, phase-array antenna components), etc. The selection and arrangement of the components of the transmit circuitry 318, receive circuitry 320, RF circuitry 322, RFFE 324, and antenna panels 326 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 314 may include one or more instances of control circuitry (not shown) to provide control functions for the transmit/receive components.

A UE reception may be established by and via the antenna panels 326, RFFE 324, RF circuitry 322, receive circuitry 320, digital baseband circuitry 316, and protocol processing circuitry 314. In some embodiments, the antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and antenna panels 326. In some embodiments, the transmit components of the UE 304 may apply a spatial filter to the data to be transmitted to form a transmit beam emitted by the antenna elements of the antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with like-named components of the UE 302. In addition to performing data transmission/reception as described above, the components of the AN 308 may perform various logical functions that include, for example, RNC functions such as radio bearer management, uplink and downlink dynamic radio resource management, and data packet scheduling.

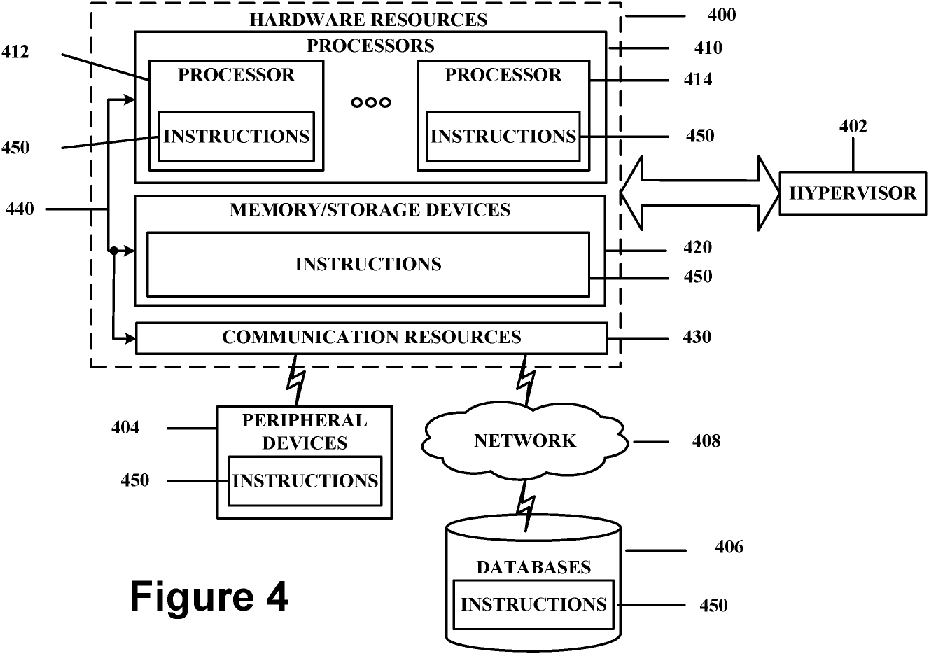

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400 including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400.

The processors 410 may include, for example, a processor 412 and a processor 414. The processors 410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 420 may include main memory, disk storage, or any suitable combination thereof. The memory/storage devices 420 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 430 may include interconnection or network interface controllers, components, or other suitable devices to communicate with one or more peripheral devices 404 or one or more databases 406 or other network elements via a network 408. For example, the communication resources 430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 450 may comprise software, a program, an application, an applet, an app, or other executable code for causing at least any of the processors 410 to perform any one or more of the methodologies discussed herein. The instructions 450 may reside, completely or partially, within at least one of the processors 410 (e.g., within the processor’s cache memory), the memory/storage devices 420, or any suitable combination thereof. Furthermore, any portion of the instructions 450 may be transferred to the hardware resources 400 from any combination of the peripheral devices 404 or the databases 406. Accordingly, the memory of processors 410, the memory/storage devices 420, the peripheral devices 404, and the databases 406 are examples of computer-readable and machine-readable media.

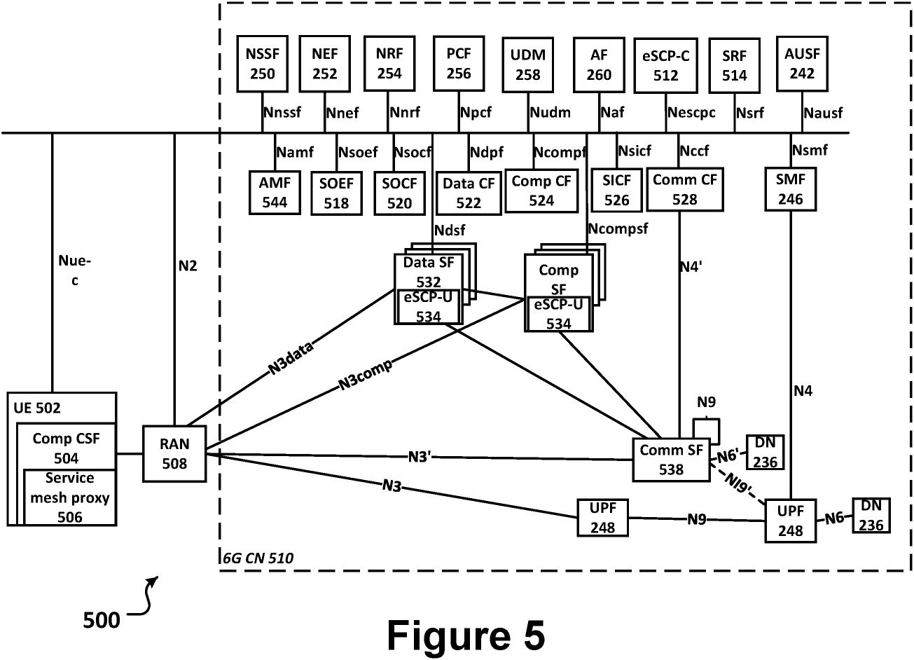

FIG. 5 illustrates a network 500 in accordance with various embodiments. The network 500 may operate in a matter consistent with 3GPP technical specifications or technical reports for 6G systems. In some embodiments, the network 500 may operate concurrently with network 200. For example, in some embodiments, the network 500 may share one or more frequency or bandwidth resources with network 200. As one specific example, a UE (e.g., UE 502) may be configured to operate in both network 500 and network 200. Such configuration may be based on a UE including circuitry configured for communication with frequency and bandwidth resources of both networks 200 and 500. In general, several elements of network 500 may share one or more characteristics with elements of network 200. For the sake of brevity and clarity, such elements may not be repeated in the description of network 500.

The network 500 may include a UE 502, which may include any mobile or non-mobile computing device designed to communicate with a RAN 508 via an over-the-air connection. The UE 502 may be similar to, for example, UE 202. The UE 502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 5, in some embodiments the network 500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 5, the UE 502 may be communicatively coupled with an AP such as AP 206 as described with respect to FIG. 2. Additionally, although not specifically shown in FIG. 5, in some embodiments the RAN 508 may include one or more ANss such as AN 208 as described with respect to FIG. 2. The RAN 508 and/or the AN of the RAN 508 may be referred to as a base station (BS), a RAN node, or using some other term or name.

The UE 502 and the RAN 508 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 508 may allow for communication between the UE 502 and a 6G core network (CN) 510. Specifically, the RAN 508 may facilitate the transmission and reception of data between the UE 502 and the 6G CN 510. The 6G CN 510 may include various functions such as NSSF 250, NEF 252, NRF 254, PCF 256, UDM 258, AF 260, SMF 246, and AUSF 242. The 6G CN 510 may additional include UPF 248 and DN 236 as shown in FIG. 5.

Additionally, the RAN 508 may include various additional functions that are in addition to, or alternative to, functions of a legacy cellular network such as a 4G or 5G network. Two such functions may include a Compute Control Function (Comp CF) 524 and a Compute Service Function (Comp SF) 536. The Comp CF 524 and the Comp SF 536 may be parts or functions of the Computing Service Plane. Comp CF 524 may be a control plane function that provides functionalities such as management of the Comp SF 536, computing task context generation and management (e.g., create, read, modify, delete), interaction with the underlaying computing infrastructure for computing resource management, etc.. Comp SF 536 may be a user plane function that serves as the gateway to interface computing service users (such as UE 502) and computing nodes behind a Comp SF instance. Some functionalities of the Comp SF 536 may include: parse computing service data received from users to compute tasks executable by computing nodes; hold service mesh ingress gateway or service API gateway; service and charging policies enforcement; performance monitoring and telemetry collection, etc. In some embodiments, a Comp SF 536 instance may serve as the user plane gateway for a cluster of computing nodes. A Comp CF 524 instance may control one or more Comp SF 536 instances.

Two other such functions may include a Communication Control Function (Comm CF) 528 and a Communication Service Function (Comm SF) 538, which may be parts of the Communication Service Plane. The Comm CF 528 may be the control plane function for managing the Comm SF 538, communication sessions creation/configuration/releasing, and managing communication session context. The Comm SF 538 may be a user plane function for data transport. Comm CF 528 and Comm SF 538 may be considered as upgrades of SMF 246 and UPF 248, which were described with respect to a 5G system in FIG. 2. The upgrades provided by the Comm CF 528 and the Comm SF 538 may enable service-aware transport. For legacy (e.g., 4G or 5G) data transport, SMF 246 and UPF 248 may still be used.

Two other such functions may include a Data Control Function (Data CF) 522 and Data Service Function (Data SF) 532 may be parts of the Data Service Plane. Data CF 522 may be a control plane function and provides functionalities such as Data SF 532 management, Data service creation/configuration/releasing, Data service context management, etc. Data SF 532 may be a user plane function and serve as the gateway between data service users (such as UE 502 and the various functions of the 6G CN 510) and data service endpoints behind the gateway. Specific functionalities may include include: parse data service user data and forward to corresponding data service endpoints, generate charging data, report data service status.

Another such function may be the Service Orchestration and Chaining Function (SOCF) 520, which may discover, orchestrate and chain up communication/computing/data services provided by functions in the network. Upon receiving service requests from users, SOCF 520 may interact with one or more of Comp CF 524, Comm CF 528, and Data CF 522 to identify Comp SF 536, Comm SF 538, and Data SF 532 instances, configure service resources, and generate the service chain, which could contain multiple Comp SF 536, Comm SF 538, and Data SF 532 instances and their associated computing endpoints. Workload processing and data movement may then be conducted within the generated service chain. The SOCF 520 may also responsible for maintaining, updating, and releasing a created service chain.

Another such function may be the service registration function (SRF) 514, which may act as a registry for system services provided in the user plane such as services provided by service endpoints behind Comp SF 536 and Data SF 532 gateways and services provided by the UE 502. The SRF 514 may be considered a counterpart of NRF 254, which may act as the registry for network functions.

Other such functions may include an evolved service communication proxy (eSCP) and service infrastructure control function (SICF) 526, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 512 and eSCP-U 534, for control plane service communication proxy and user plane service communication proxy, respectively. The SICF 526 may control and configure eCSP instances in terms of service traffic routing policies, access rules, load balancing configurations, performance monitoring, etc.

Another such function is the AMF 544. The AMF 544 may be similar to 244, but with additional functionality. Specifically, the AMF 544 may include potential functional repartition, such as move the message forwarding functionality from the AMF 544 to the RAN 508.

Another such function is the service orchestration exposure function (SOEF) 518. The SOEF may be configured to expose service orchestration and chaining services to external users such as applications.

The UE 502 may include an additional function that is referred to as a computing client service function (comp CSF) 504. The comp CSF 504 may have both the control plane functionalities and user plane functionalities, and may interact with corresponding network side functions such as SOCF 520, Comp CF 524, Comp SF 536, Data CF 522, and/or Data SF 532 for service discovery, request/response, compute task workload exchange, etc. The Comp CSF 504 may also work with network side functions to decide on whether a computing task should be run on the UE 502, the RAN 508, and/or an element of the 6G CN 510.

The UE 502 and/or the Comp CSF 504 may include a service mesh proxy 506. The service mesh proxy 506 may act as a proxy for service-to-service communication in the user plane. Capabilities of the service mesh proxy 506 may include one or more of addressing, security, load balancing, etc.

### Example Procedures

In some embodiments, the electronic device(s), network(s), system(s), chip(s) or component(s), or portions or implementations thereof, of FIGS. 2-4, or some other figure herein, may be configured to perform one or more processes, techniques, or methods as described herein, or portions thereof.

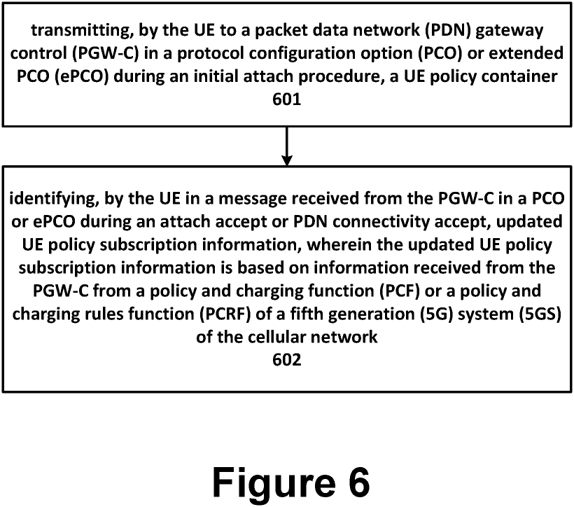

One such process is depicted in FIG. 6. The process of FIG. 6 may be performed by a user equipment (UE) or portion thereof in a cellular network. The process may include transmitting, at 601 by the UE to a packet data network (PDN) gateway control (PGW-C) in a protocol configuration option (PCO) or extended PCO (ePCO) during an initial attach procedure, a UE policy container; and identifying, at 602 by the UE in a message received from the PGW-C in a PCO or ePCO during an attach accept or PDN connectivity accept, updated UE policy subscription information, wherein the updated UE policy subscription information is based on information received from the PGW-C from a policy and charging function (PCF) or a policy and charging rules function (PCRF) of a fifth generation (5G) system (5GS) of the cellular network.

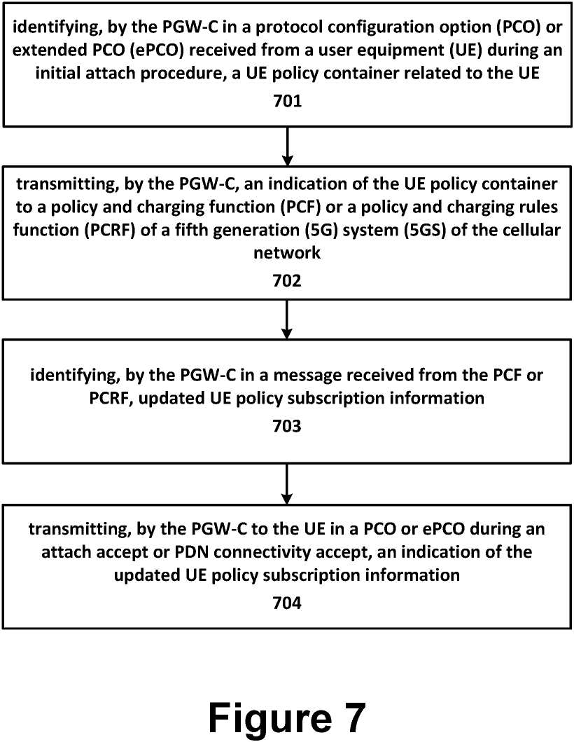

Another such process is depicted in FIG. 7. The process of FIG. 7 may be performed by a packet data network (PDN) gateway control (PGW-C) or a portion thereof in a cellular network. The process may include identifying, at 701 by the PGW-C in a protocol configuration option (PCO) or extended PCO (ePCO) received from a user equipment (UE) during an initial attach procedure, a UE policy container related to the UE; transmitting, by the PGW-C, an indication of the UE policy container to a policy and charging function (PCF) or a policy and charging rules function (PCRF) of a fifth generation (5G) system (5GS) of the cellular network; identifying, at 702 by the PGW-C in a message received from the PCF or PCRF, updated UE policy subscription information; and transmitting, at 703 by the PGW-C to the UE in a PCO or ePCO during an attach accept or PDN connectivity accept, an indication of the updated UE policy subscription information.

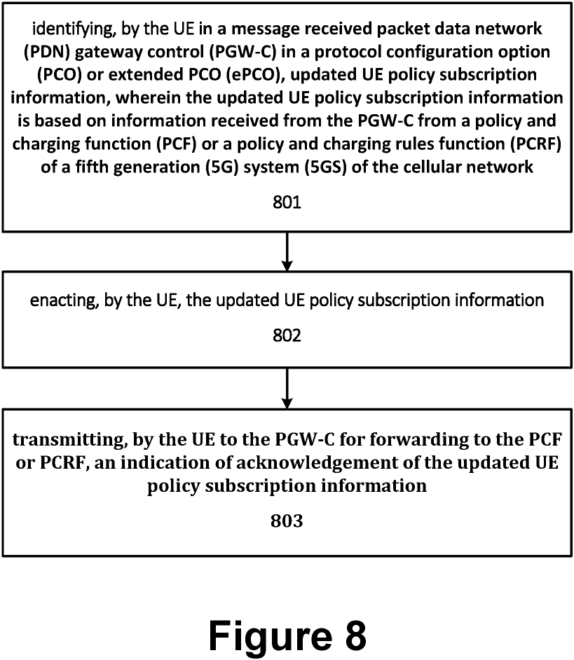

Another such process is depicted in FIG. 8. The process of FIG. 8 may be performed by a user equipment (UE) or portion thereof in a cellular network. The process may include identifying, at 801 by the UE in a message received packet data network (PDN) gateway control (PGW-C) in a protocol configuration option (PCO) or extended PCO (ePCO), updated UE policy subscription information, wherein the updated UE policy subscription information is based on information received from the PGW-C from a policy and charging function (PCF) or a policy and charging rules function (PCRF) of a fifth generation (5G) system (5GS) of the cellular network; enacting, at 802 by the UE, the updated UE policy subscription information; and transmitting, at 803 by the UE to the PGW-C for forwarding to the PCF or PCRF, an indication of acknowledgement of the updated UE policy subscription information.

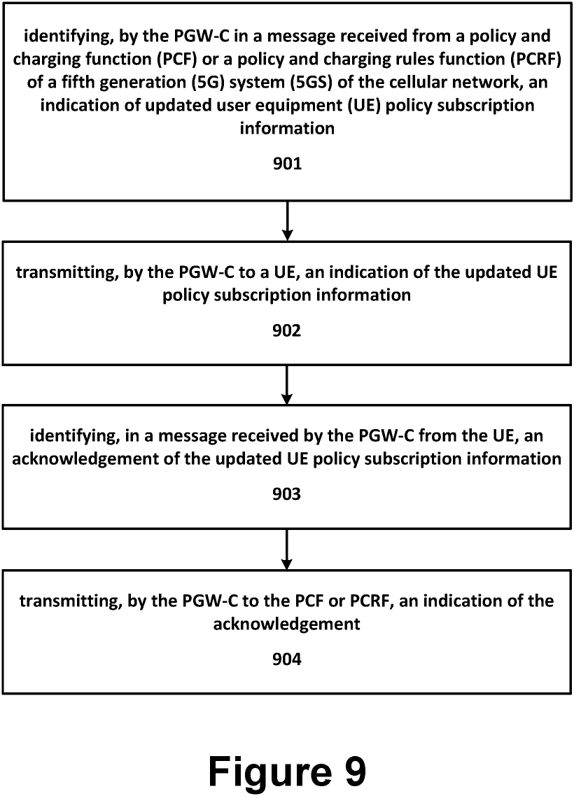

Another such process is depicted in FIG. 9. The process of FIG. 9 may be performed by a packet data network (PDN) gateway control (PGW-C) or a portion thereof in a cellular network. The process may include identifying, at 901 by the PGW-C in a message received from a policy and charging function (PCF) or a policy and charging rules function (PCRF) of a fifth generation (5G) system (5GS) of the cellular network, an indication of updated user equipment (UE) policy subscription information; transmitting, at 902 by the PGW-C to a UE, an indication of the updated UE policy subscription information; identifying, at 903 in a message received by the PGW-C from the UE, an acknowledgement of the updated UE policy subscription information; and transmitting, at 904 by the PGW-C to the PCF or PCRF, an indication of the acknowledgement.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include PCF or PCRF provides the update UE Policy to UE via PGW-C when the UE Policy is updated or the UE Policy Support/Request indication is received.

Example 2 may include the method of example 1 or some other example herein, wherein the UE Policy is contained in the UE Policy Container.

Example 3 may include the method of example 1 or some other example herein, wherein the UE Policy is sent to UE by PGW-C via ePCO or PCO.

Example 4 may include the method of example 1 or some other example herein, when the UE receives the UE Policy, it acknowledges the reception to PGW-C and PGW-C further forwards the acknowledgement to PCF or PCRF.

Example 5 may include t the method of example 1 or some other example herein, wherein the UE Policy is URSP.

Example 6 may include the method of example 1 or some other example herein, wherein the UE Policy is ANDSP.

Example 7 may include the method of example 1 or some other example herein, wherein the UE Policy Support/Request indication is carried in the UE Policy Container in Attach Request message.

Example 8 may include the method of example 1 or some other example herein, wherein the UE Policy Support/Request indication is carried in the UE Policy Container in PDN Connectivity Request message.

Example 9 may include the method of example 1 or some other example herein, wherein the UE Policy is carried in the UE Policy Container in the Attach Accept message.

Example 10 may include the method of example 1 or some other example herein, wherein the UE Policy is carried in the UE Policy Container in the PDN Connectivity Accept message.

Example 11 may include the method of example 1 or some other example herein, wherein the UE Policy is carried in a new message.

Example 12 may include the method of example 1 or some other example herein, wherein the UE Policy is carried in Update Bearer Request message.

Example 13 may include PGW-C provides the update UE Policy to UE when the UE Policy is updated or the UE Policy Support/Request indication is received.

Example 14 may include method of example 13 or some other example herein, wherein the UE Policy is contained in the UE Policy Container.

Example 15 may include the method of example 13 or some other example herein, wherein the UE Policy is sent to UE by PGW-C via ePCO or PCO.

Example 16 may include the method of example 13 or some other example herein, when the UE receives the UE Policy, it acknowledges the reception to PGW-C.

Example 17 may include the method of example 13 or some other example herein, wherein the UE Policy is URSP.

Example 18 may include the method of example 13 or some other example herein, wherein the UE Policy is ANDSP.

Example 19 may include the method of example 13 or some other example herein, wherein the UE Policy Support/Request indication is carried in the UE Policy Container in Attach Request message.

Example 20 may include the method of example 13 or some other example herein, wherein the UE Policy Support/Request indication is carried in the UE Policy Container in PDN Connectivity Request message.

Example 21 may include the method of example 13 or some other example herein, wherein the UE Policy is carried in the UE Policy Container in the Attach Accept message.

Example 22 may include the method of example 13 or some other example herein, wherein the UE Policy is carried in the UE Policy Container in the PDN Connectivity Accept message.

Example 23 may include the method of example 13 or some other example herein, wherein the UE Policy is carried in a new message.

Example 24 may include the method of example 13 or some other example herein, wherein the UE Policy is carried in Update Bearer Request message.

Example 25 includes a method to be performed by a user equipment (UE) or portion thereof in a cellular network, wherein the method comprises: transmitting, by the UE to a packet data network (PDN) gateway control (PGW-C) in a protocol configuration option (PCO) or extended PCO (ePCO) during an initial attach procedure, a UE policy container; and identifying, by the UE in a message received from the PGW-C in a PCO or ePCO during an attach accept or PDN connectivity accept, updated UE policy subscription information, wherein the updated UE policy subscription information is based on information received from the PGW-C from a policy and charging function (PCF) or a policy and charging rules function (PCRF) of a fifth generation (5G) system (5GS) of the cellular network.

Example 26 includes a method to be performed by a packet data network (PDN) gateway control (PGW-C) or a portion thereof in a cellular network, wherein the method comprises: identifying, by the PGW-C in a protocol configuration option (PCO) or extended PCO (ePCO) received from a user equipment (UE) during an initial attach procedure, a UE policy container related to the UE; transmitting, by the PGW-C, an indication of the UE policy container to a policy and charging function (PCF) or a policy and charging rules function (PCRF) of a fifth generation (5G) system (5GS) of the cellular network; identifying, by the PGW-C in a message received from the PCF or PCRF, updated UE policy subscription information; and transmitting, by the PGW-C to the UE in a PCO or ePCO during an attach accept or PDN connectivity accept, an indication of the updated UE policy subscription information.

Example 27 includes a method to be performed by a user equipment (UE) or portion thereof in a cellular network, wherein the method comprises: identifying, by the UE in a message received packet data network (PDN) gateway control (PGW-C) in a protocol configuration option (PCO) or extended PCO (ePCO), updated UE policy subscription information, wherein the updated UE policy subscription information is based on information received from the PGW-C from a policy and charging function (PCF) or a policy and charging rules function (PCRF) of a fifth generation (5G) system (5GS) of the cellular network; enacting, by the UE, the updated UE policy subscription information; and transmitting, by the UE to the PGW-C for forwarding to the PCF or PCRF, an indication of acknowledgement of the updated UE policy subscription information.

Example 28 includes a method to be performed by a packet data network (PDN) gateway control (PGW-C) or a portion thereof in a cellular network, wherein the method comprises: identifying, by the PGW-C in a message received from a policy and charging function (PCF) or a policy and charging rules function (PCRF) of a fifth generation (5G) system (5GS) of the cellular network, an indication of updated user equipment (UE) policy subscription information; transmitting, by the PGW-C to a UE, an indication of the updated UE policy subscription information; identifying, in a message received by the PGW-C from the UE, an acknowledgement of the updated UE policy subscription information; and transmitting, by the PGW-C to the PCF or PCRF, an indication of the acknowledgement.

Example 29 includes a method to be performed by a user equipment (UE), the method comprising: transmitting, to a network entity of a cellular network, an indication of a UE policy container during an initial attach procedure; and identifying, based on the transmission of the indication of the UE policy container, updated policy subscription information.

Example 30 includes the method of example 29, and/or some other example herein, wherein the network entity is a packet data network (PDN) gateway control (PGW-C).

Example 31 includes the method of any of examples 29-30, and/or some other example herein, wherein the indication of the UE policy container is a protocol configuration option (PCO) or extended PCO (ePCO).

Example 32 includes the method of any of examples 29-31, and/or some other example herein, wherein the updated policy subscription information is received during an attach accept or packet data network (PDN) connectivity accept.

Example 33 includes the method of any of examples 29-32, and/or some other example herein, wherein the updated policy subscription information is based on information received by the network entity from a policy and charging function (PCF).

Example 34 includes the method of any of examples 29-33, and/or some other example herein, wherein the updated policy subscription information is based on information received by the network entity from a policy and charging rules function (PCRF).

Example 35 includes a method to be performed by a packet data network (PDN) gateway control (PGW-C) entity of a cellular network, wherein the method comprises: identifying, from a user equipment (UE) during an initial attach procedure, an indication of a UE policy container; identifying, based on the UE policy container, updated policy subscription information; and transmitting, to the UE, an indication of the updated policy subscription information.

Example 36 includes the method of example 35, and/or some other example herein, wherein the indication of the UE policy container is a protocol configuration option (PCO).

Example 37 includes the method of any o examples 35-36, and/or some other example herein, wherein the indication of the UE policy container is an extended protocol configuration option (ePCO).

Example 38 includes the method of any of examples 35-37, and/or some other example herein, further comprising transmitting the indication of the updated policy subscription information in an attach accept transmission.

Example 39 includes the method of any of examples 35-38, and/or some other example herein, further comprising transmitting the indication of the updated policy subscription information in a packet data network (PDN) connectivity accept transmission.

Example 40 includes the method of any of examples 35-39, and/or some other example herein, wherein the updated policy subscription information is based on information received by the network entity from a policy and charging function (PCF).

Example 41 includes the method of any of examples 35-40, and/or some other example herein, wherein the updated policy subscription information is based on information received by the network entity from a policy and charging rules function (PCRF).

Example 42 includes a method to be performed by a user equipment (UE), the method comprising: identifying, from a network entity, a received indication of updated UE policy subscription information; enacting the updated UE policy subscription information; and transmitting, to the network entity, an indication of acknowledgement of the updated UE policy subscription information.

Example 43 includes the method of example 42, and/or some other example herein, wherein the network entity is a packet data network (PDN) gateway control (PGW-C).

Example 44 includes the method of any of examples 42-43, and/or some other example herein, wherein the indication of the updated UE policy subscription information is received in a protocol configuration option (PCO).

Example 45 includes the method of any of examples 42-44, and/or some other example herein, wherein the indication of the updated UE policy subscription information is received in an extended protocol configuration option (ePCO).

Example 46 includes the method of any of examples 42-45, and/or some other example herein, wherein the updated UE policy subscription information is based on information received by the network entity from a policy and charging function (PCF).

Example 47 includes the method of any of examples 42-46, and/or some other example herein, wherein the updated UE policy subscription information is based on information received by the network entity from a policy and charging rules function (PCRF).

Example 48 includes a method to be performed by a packet data network (PDN) gateway control (PGW-C) entity of a cellular network, wherein the method comprises: identifying, from a network entity, a received indication of updated user equipment (UE) policy subscription information; transmitting, to the UE, an indication of the updated UE policy subscription information; identifying, in a message received from the UE, an acknowledgement of the updated UE policy subscription information; and transmitting, to the network entity, an indication of the acknowledgement.

Example 49 includes the method of example 48, and/or some other example herein, wherein the network entity is a policy and charging function (PCF).

Example 50 includes the method of any of examples 48-49, and/or some other example herein, wherein the network entity is a policy and charging rules function (PCRF).

Example 51 includes the method of any of examples 48-50, and/or some other example herein, wherein the indication of the updated UE policy subscription information is transmitted to the UE in a protocol configuration option (PCO).

Example 52 includes the method of any of examples 48-51, and/or some other example herein, wherein the indication of the updated UE policy subscription information is transmitted to the UE in an extended protocol configuration option (ePCO).

Example Z01 may include an apparatus comprising means to perform one or more elements of a method described in or related to any of examples 1-52, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-52, or any other method or process described herein.

Example Z03 may include an apparatus comprising logic, modules, or circuitry to perform one or more elements of a method described in or related to any of examples 1-52, or any other method or process described herein.

Example Z04 may include a method, technique, or process as described in or related to any of examples 1-52, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-52, or portions thereof.

Example Z06 may include a signal as described in or related to any of examples 1-52, or portions or parts thereof.

Example Z07 may include a datagram, packet, frame, segment, protocol data unit (PDU), or message as described in or related to any of examples 1-52, or portions or parts thereof, or otherwise described in the present disclosure.

Example Z08 may include a signal encoded with data as described in or related to any of examples 1-52, or portions or parts thereof, or otherwise described in the present disclosure.

Example Z09 may include a signal encoded with a datagram, packet, frame, segment, protocol data unit (PDU), or message as described in or related to any of examples 1-52, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-52, or portions thereof.

Example Z11 may include a computer program comprising instructions, wherein execution of the program by a processing element is to cause the processing element to carry out the method, techniques, or process as described in or related to any of examples 1-52, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### ABBREVIATIONS

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | | | | | |
|---|---|---|---|---|---|
| 3GPP | Third Generation Partnership Project | ARP | Allocation and Retention Priority | C-RNTI | Cell Radio Network Temporary Identity |
| 4G | Fourth Generation | ARQ | Automatic Repeat Request | CA | Carrier Aggregation, Certification Authority |
| 5G 5GC 5G | Fifth Generation Core network | AS | Access Stratum | | |
| AC | Application Client | ASP | Application Service Provider | CAPEX | CAPital EXpenditure |
| ACR | Application Context Relocation | ASN.1 | Abstract Syntax Notation One | CBRA | Contention Based Random Access |
| ACK | Acknowledgement | AUSF | AuthenticationServer Function | CC | Component Carrier, Country Code, Cryptographic Checksum |
| ACID | Application Client Identification | AWGN | AdditiveWhite Gaussian Noise | CCA | Clear Channel Assessment |
| AF | Application Function | BAP | Backhaul Adaptation Protocol | CCE | Control Channel Element |
| AM | Acknowledged Mode | BCH | Broadcast Channel | CCCH | Common Control Channel |
| AMBR | Aggregate Maximum Bit Rate | BER | Bit Error Ratio | CE | Coverage Enhancement |
| AMF | Access and Mobility Management Function | BFD | Beam Failure Detection | CDM | Content Delivery Network |
| AN | Access Network | BLER | Block Error Rate | CDMA | Code-Division Multiple Access |
| ANR | Automatic Neighbour Relation | BPSK | Binary Phase Shift Keying | CDR | Charging Data Request |
| AOA | Angle of Arrival | BRAS | Broadband Remote Access Server | CDR | Charging Data Response |
| AP | Application Protocol, Antenna Port, Access Point | BSS | Business Support System | CFRA | Contention Free Random Access |
| API | Application Programming Interface | BS | Base Station | CSI-IM | CSI Interference Measurement |
| APN | Access Point Name | BSR | Buffer Status Report | CSI-RS | CSI Reference Signal |
| CG | Cell Group | BW | Bandwidth | CSI-RSRP | CSI reference signal received power |
| CGF | Charging Gateway Function | BWP | Bandwidth PartDescriptor | CSI-RSRQ | CSI reference signal received quality |
| CHF | Charging Function | CPD | Customer Premise Equipment | CSI-SINR | CSI signal-to-noise and interference ratio |
| CI | Cell Identity | CPE | Connection Point | CSMA | Carrier Sense Multiple Access |
| CID | Cell-ID (e.g., positioning method) | CPICH | Channel Common Pilot | CSMA/CA | CSMA with collision avoidance |
| CIM | Common Information Model | CQI | Channel Quality Indicator | CSS | Common Search Space, Cell- specific Search Space |
| CIR | Carrier to Interference Ratio | CPU | CSI processing unit, Central Processing Unit C/R Command/Response field bit | CTF | Charging Trigger Function |
| CK | Cipher Key | CRAN | Cloud Radio Access Network, Cloud | CTS | Clear-to-Send |
| CM | Connection Management, Conditional | CRB | Common Resource Block | CW | Codeword |
| CMAS | Commercial Mobile Alert Service | CRC | Cyclic Redundancy Check | CWS | Contention Window Size |
| CMD | Command | CRI | Channel-State Information Resource Indicator, CSI-RS Resource Indicator | D2D | Device-to-Device |
| CMS | Cloud Management System | C-RNTI | Cell RNTI | DC | Dual Connectivity, Direct Current |
| CO | Conditional Optional | CS | Circuit Switched | DCI | Downlink Control Information |
| CoMP | Coordinated MultiPoint | CSCF | call session control function | DF | Deployment Flavour |
| CORESET | Control Resource Set | CSAR | Cloud Service Archive | EHE | Edge Hosting Environment |
| COTS | Commercial Off-The-Shelf | CSI | Channel-State Information | EGMF | Exposure Governance Management Function |
| CP | Control Plane, Cyclic Prefix, Connection Point | ECCA | extended clear channel assessment, extended CCA | EGPRS | Enhanced GPRS |
| DL | Downlink | ECCE | Enhanced Control Channel Element, Enhanced CCE | EIR | Equipment Identity Register |
| DMTF | Distributed Management Task Force | ED | Energy Detection | eLAA | enhanced Licensed Assisted Access, enhanced LAA |
| DPDK | Data Plane Development Kit | EDGE | Enhanced Datarates for GSM Evolution (GSM Evolution) | EM | Element Manager |
| DM-RS, DMRS | Demodulation Reference Signal | EAS | Edge Application Server | eMBB | Enhanced Mobile Broadband |
| DN | Data network | EASID | Edge Application Server Identification | EMS | Element Management System |
| DNN | Data Network Name | ECS | Edge Configuration Server | eNB | evolved NodeB, E-UTRAN Node B |
| | | | | EN-DC | E-UTRA-NR Dual Connectivity |
| DNAI | Data Network Access Identifier | ECSP | Edge Computing Service Provider | EPC | Evolved Packet Core |
| | | | | EPDCCH | enhanced PDCCH, enhanced Physical Downlink Control Cannel |
| DRB | Data Radio Bearer | EDN | Edge Data Network | EPRE | Energy per resource element |
| DRS | Discovery Reference Signal | EEC | Edge Enabler Client | EPS | Evolved Packet System |
| DRX | Discontinuous Reception | EECID | Edge Enabler Client Identification | FQDN | Fully Qualified Domain Name |
| DSL | Domain Specific Language. Digital Subscriber Line | EES | Edge Enabler Server | G-RNTI | GERAN Radio Network Temporary Identity |
| | | | | GERAN | GSM EDGE RAN, GSM EDGE Radio Access Network |
| DSLAM | DSL Access Multiplexer | EESID | Edge Enabler Server Identification | GGSN | Gateway GPRS Support Node |
| DwPTS | Downlink Pilot Time Slot | FACH | Forward Access Channel | GLONASS | GLObal’naya NAvigatsionnaya Sputnikovaya Sistema (Engl.: Global Navigation Satellite System) |
| E-LAN | Ethernet Local Area Network | FAUSCH | Fast Uplink Signalling Channel | gNB | Next Generation NodeB |
| E2E | End-to-End | FB | Functional Block | gNB-CU | gNB-centralized unit, Next Generation NodeB centralized unit |
| EAS | Edge Application Server | FBI | Feedback Information | gNB-DU | gNB-distributed unit, Next Generation NodeB distributed unit |
| EREG | enhanced REG, enhanced resource element groups | FCC | Federal Communications Commission | GNSS | Global Navigation Satellite System |
| ETSI | European Telecommunications Standards Institute | FCCH | Frequency Correction Channel | GPRS | General Packet Radio Service |
| ETWS | Earthquake and Tsunami Warning System | FDD | Frequency Division Duplex | GPSI | Generic Public Subscription Identifier |
| eUICC | embedded UICC, embedded Universal Integrated Circuit Card | FDM | Frequency Division Multiplex | IEI | Information Element Identifier |
| E-UTRA | Evolved UTRA | FDMA | Frequency Division Multiple Access | IEIDL | Information Element Identifier Data Length |
| E-UTRAN | Evolved UTRAN | FE | Front End | IETF | Internet Engineering Task Force |
| EV2X | Enhanced V2X | FEC | Forward Error Correction | IF | Infrastructure |
| F1AP | F1 Application Protocol | FFS | For Further Study | IIOT | Industrial Internet of Things |
| F1-C | F1 Control plane interface | FFT | Fast Fourier Transformation | IM | Interference Measurement, Intermodulation, IP Multimedia |
| F1-U | F1 User plane interface | feLAA | further enhanced Licensed Assisted Access, further enhanced LAA | IMC | IMS Credentials |
| FACCH | Fast Associated Control Channel | FN | Frame Number | IMEI | International Mobile Equipment Identity |
| FACCH/F | Fast Associated Control Channel/Full rate | FPGA | Field-Programmable Gate Array | IMGI | International mobile group identity |
| FACCH/H | Fast Associated Control Channel/Half rate | FR | Frequency Range | IMPI | IP Multimedia Private Identity |
| GSM | Global System for Mobile Communications, Groupe Special Mobile | HSN | Hopping Sequence Number | IMPU | IP Multimedia PUblic identity |
| GTP | GPRS Tunneling Protocol | HSPA | High Speed Packet Access | IMS | IP Multimedia Subsystem |
| GTP-UGPRS | Tunnelling Protocol for User Plane | HSS | Home Subscriber Server | IMSI | International Mobile Subscriber Identity |
| GTS | Go To Sleep Signal (related to WUS) | HSUPA | High Speed Uplink Packet Access | IoT | Internet of Things |
| GUMMEI | Globally Unique MME Identifier | HTTP | Hyper Text Transfer Protocol | IP | Internet Protocol |
| GUTI | Globally Unique Temporary UE Identity | HTTPS | Hyper Text Transfer ProtocolSecure (https is http/1.1 over SSL, i.e. port 443) | Ipsec | IP Security, Internet Protocol Security |
| HARQ | Hybrid ARQ, Hybrid Automatic Repeat Request | I-Block | Block Information | LI | Layer Indicator |
| HANDO | Handover | ICCID | Integrated Circuit Card Identification | LLC | Logical Link Control, Low Layer Compatibility |
| HFN | HyperFrame Number | IAB | Integrated Access and Backhaul | LMF | Location Management Function |
| HHO | Hard Handover | ICIC | Inter-Cell Interference Coordination | LOS | Line of Sight |
| HLR | Home Location Register | ID | Identity, identifier | LPLMN | Local PLMN |
| HN | Home Network | IDFT | Inverse Discrete Fourier Transform | LPP | LTE Positioning Protocol |
| HO | Handover | IE | Information element | LSB | Least Significant Bit |
| HPLMN | Home Public Land Mobile Network | IBE | In-Band Emission | LTE | Long Term Evolution |
| HSDPA | High Speed Downlink Packet Access | IEEE | Institute of Electrical and Electronics Engineers | LWA | LTE-WLAN aggregation |
| IP-CAN | IP-Connectivity Access Network | Ki | Individual subscriber authentication key | LWIP | LTE/WLAN Radio Level Integration with IPsec Tunnel |
| IP-M | IP Multicast | KPI | Key Performance Indicator | LTE | Long Term Evolution |
| IPv4 | Internet Protocol Version 4 | KQI | Key Quality Indicator | M2M | Machine-to-Machine |
| IPv6 | Internet ProtocolVersion 6 | KSI | Key Set Identifier | MAC | Medium Access Control (protocol layering context) |
| IR | Infrared | ksps | kilo-symbols per second | MAC | Message authentication code (security/encryption context) |
| IS | In Sync | KVM | Kernel Virtual Machine | MAC-A | MAC used for authentication and key agreement (TSG T WG3 context) |
| IRP | Integration Reference Point | L1 | Layer 1 (physical layer) | MPLS | MultiProtocol Label Switching |
| ISDN | Integrated Services Digital Network | L1-RSRP | Layer 1 reference signal received power | MS | Mobile Station |
| ISIM | IM Services Identity Module | L2 | Layer 2 (data link layer) | MSB | Most Significant Bit |
| ISO | International Organisation for Standardisation | L3 | Layer 3 (network layer) | MSC | Mobile Switching Centre |
| ISP | Internet Service Provider | LAA | Licensed Assisted Access | MSI | Minimum System Information, MCH Scheduling Information |
| IWF | Interworking-Function | LAN | Local Area Network | MSID | Mobile Station Identifier |
| I-WLAN | Interworking WLAN Constraint length of the convolutional code, USIM Individual key kB Kilobyte (1000 bytes) kbps kilo-bits per second Kc Ciphering key MAC-IMAC used for data integrity of signalling messages (TSG T WG3 context) | LADN | Local Area Data Network | MSIN | Mobile Station Identification Number |
| MANO | Management and Orchestration | LBT | Listen Before Talk | MSISDN | Mobile Subscriber ISDN Number |
| MBMS | Multimedia Broadcast and Multicast Service | LCM | LifeCycle Management | MT | Mobile Terminated, Mobile Termination |
| MBSFN | Multimedia Broadcast multicast service Single Frequency Network | LCR | Low Chip Rate | MTC | Machine-Type Communications |
| MCC | Mobile Country Code | LCS | Location Services | mMTCmassive | MTC, massive Machine-Type Communications |
| MCG | Master Cell Group | LCID | Logical Channel ID | MU-MIMO | Multi User MIMO |
| MCOT | Maximum Channel Occupancy Time | MIB | Master Information Block, Management Information Base | MWUS | MTC wake-up signal, MTC WUS |
| MCS | Modulation and coding scheme | MIMO | Multiple InputMultiple Output | NACK | Negative Acknowledgement |
| MDAF | Management Data Analytics Function | MLC | Mobile Location Centre | NAI | Network Access Identifier |
| MDAS | Management Data Analytics Service | MM | Mobility Management | NS | Network Service |
| MDT | Minimization of Drive Tests | MME | Mobility Management Entity | NSA | Non-Standalone operation mode |
| ME | Mobile Equipment | MN | Master Node | NSD | Network Service Descriptor |
| MeNB | master eNB | MNO | Mobile Network Operator | NSR | Network Service Record |
| MER | Message Error Ratio | MO | Measurement Object, Mobile Originated | NSSAI | Network Slice Selection Assistance Information |
| MGL | Measurement Gap Length | MPBCH | MTC Physical Broadcast Channel | S-NNSAI | Single-NSSAI |
| MGRP | Measurement Gap Repetition Period | MPDCCH | MTC Physical Downlink Control CHannel | NSSF | Network Slice Selection Function |
| NAS | Non-Access Stratum, Non- Access Stratum layer | MPDSCH | MTC Physical Downlink Shared CHannel | NW | Network |
| NCT | Network Connectivity Topology | MPRACH | MTC Physical Random Access CHannel | NWUS | Narrowband wake-up signal, Narrowband WUS |
| NC-JT | Non-Coherent Joint Transmission | MPUSCH | MTC Physical Uplink Shared Channel | NZP | Non-Zero Power |
| NEC | Network Capability Exposure | N-PoP | Network Point of Presence | O&M | Operation and Maintenance |
| NE-DC | NR-E-UTRA Dual Connectivity | NMIB, N-MIB | Narrowband MIB | ODU2 | Optical channel Data Unit - type 2 |
| NEF | Network Exposure Function | NPBCH | Narrowband Physical Broadcast CHannel | OFDM | Orthogonal Frequency Division Multiplexing |
| NF | Network Function | NPDCCH | Narrowband Physical Downlink Control CHannel | OFDMA | Orthogonal Frequency Division Multiple Access |
| NFP | Network Forwarding Path | NPDSCH | Narrowband Physical Downlink Shared CHannel | OOB | Out-of-band |
| NFPD | Network Forwarding Path Descriptor | NPRACH | Narrowband Physical Random Access CHannel | OOS | Out of Sync |
| NFV | Network Functions Virtualization | NPUSCH | Narrowband Physical Uplink Shared CHannel | OPEX | OPerating EXpense |
| NFVI | NFV Infrastructure | NPSS | Narrowband Primary Synchronization Signal | PNFR | Physical Network Function Record |
| NFVO | NFV Orchestrator | NSSS | Narrowband Secondary Synchronization Signal | POC | PTT over Cellular |
| NG | Next Generation, Next Gen | NR | New Radio, Neighbour Relation | PP, PTP | Point-to-Point |
| NGEN-DC | NG-RAN E-UTRA-NR Dual Connectivity | NRF | NF Repository Function | PPP | Point-to-Point Protocol |
| | | NRS | Narrowband Reference Signal | PRACH | Physical RACH |
| NM | Network Manager | PDCCH | Physical Downlink Control Channel | PRB | Physical resource block |
| NMS | Network Management System | PDCP | Packet Data Convergence Protocol | PRG | Physical resource block group |
| OSI | Other System Information | PDN | Packet Data Network, Public Data Network | ProSe | Proximity Services, Proximity-Based Service |
| OSS | Operations Support System | PDSCH | Physical Downlink Shared Channel | PRS | Positioning Reference Signal |
| OTA | over-the-air | PDU | Protocol Data Unit | PRR | Packet Reception Radio |
| PAPR | Peak-to-Average Power Ratio | PEI | Permanent Equipment Identifiers | PS | Packet Services |
| PAR | Peak to Average Ratio | | | | |
| PBCH | Physical Broadcast Channel | PFD | Packet Flow Description | PSBCH | Physical Sidelink Broadcast Channel |
| PC | Power Control, Personal Computer | P-GW | PDN Gateway | PSDCH | Physical Sidelink Downlink Channel |
| PCC | Primary Component Carrier, Primary CC | PHICH | Physical hybrid-ARQ indicator channel | PSCCH | Physical Sidelink Control Channel |
| P-CSCF | Proxy CSCF | PHY | Physical layer | PSSCH | Physical Sidelink Shared Channel |
| PCell | Primary Cell | PLMN | Public Land Mobile Network | RLC UM | RLC Unacknowledged Mode |
| PCI | Physical Cell ID, Physical Cell Identity | PIN | Personal Identification Number | RLF | Radio Link Failure |
| PCEF | Policy and Charging Enforcement Function | PM | Performance Measurement | RLM | Radio Link Monitoring |
| PCF | Policy Control Function | PMI | Precoding Matrix Indicator | RLM-RS | Reference Signal for RLM RM Registration Management |
| PCRF | Policy Control and Charging Rules Function | PNF | Physical Network Function | RMC | Reference Measurement Channel |
| PDCP | Packet Data Convergence Protocol, Packet Data Convergence Protocol layer | PNFD | Physical Network Function Descriptor | RMSI | Remaining MSI, Remaining Minimum System Information |
| PSCell | Primary SCell | RACH | Random Access Channel | RN | Relay Node |
| PSS | Primary Synchronization Signal | RADIUS | Remote Authentication Dial In User Service | RNC | Radio Network Controller |
| PSTN | Public Switched Telephone Network | RAN | Radio Access Network | RNL | Radio Network Layer |
| PT-RS | Phase-tracking reference signal | RAND | RANDom number (used for authentication) | RNTI | Radio Network Temporary Identifier |
| PTT | Push-to-Talk | RAR | Random Access Response | ROHC | RObust Header Compression |
| PUCCH | Physical Uplink Control Channel | RAT | Radio Access Technology | RRC | Radio Resource Control, Radio Resource Control layer |
| PUSCH | Physical Uplink Shared Channel | RAU | Routing Area Update | RRM | Radio Resource Management |
| QAM | Quadrature Amplitude Modulation | | | RS | Reference Signal |
| QCI | QoS class of identifier | RB | Resource block, Radio Bearer | RSRP | Reference Signal Received Power |
| QCL | Quasi co-location | RBG | Resource block group | RSRQ | Reference Signal Received Quality |
| QFI | QoS Flow ID, QoS Flow Identifier | REG | Resource Element Group | SDSF | Structured Data Storage Function |
| QoS | Quality of Service | Rel | Release | SDT | Small Data Transmission |
| QPSK | Quadrature (Quaternary) Phase Shift Keying | REQ | REQuest | SDU | Service Data Unit |
| QZSS | Quasi-Zenith Satellite System | RF | Radio Frequency | SEAF | Security Anchor Function |
| RA-RNTI | Random Access RNTI | RI | Rank Indicator | SeNB | secondary eNB |
| RAB | Radio Access Bearer, Random Access Burst | RIV | Resource indicator value | SEPP | Security Edge Protection Proxy |
| RSSI | Received Signal Strength Indicator | RL | Radio Link | SFI | Slot format indication |
| RSU | Road Side Unit | RLC | Radio Link Control, Radio Link Control layer | SFTD | Space-Frequency Time Diversity, SFN and frame timing difference |
| RSTD | Reference Signal Time difference | RLC AM | RLC Acknowledged Mode | SFN | System Frame Number |
| RTP | Real Time Protocol | SAPI | Service Access Point Identifier | SgNB | Secondary gNB |
| RTS | Ready-To-Send | SCC | Secondary Component Carrier, Secondary CC | SGSN | Serving GPRS Support Node |
| RTT | Round Trip Time Rx Reception, Receiving, Receiver | SCell | Secondary Cell | S-GW | Serving Gateway |
| S1AP | S1 Application Protocol | SCEF | Service Capability Exposure Function | SI | System Information |
| S1-MME | S1 for the control plane | SC-FDMA | Single Carrier Frequency Division Multiple Access | SI-RNTI | System Information RNTI |
| S1-U | S1 for the user plane | SCG | Secondary Cell Group | SIB | System Information Block |
| S-CSCF | serving CSCF | SCM | Security Context Management | SIM | Subscriber Identity Module |
| | | SCS | Subcarrier Spacing | SIP | Session Initiated Protocol |
| S-GW | Serving Gateway | SCTP | Stream Control Transmission Protocol | SiP | System in Package |
| S-RNTI | SRNC Radio Network Temporary Identity | SDAP | Service Data Adaptation Protocol, Service Data Adaptation Protocol layer | SL | Sidelink |
| S-TMSI | SAE Temporary Mobile Station Identifier | SDL | Supplementary Downlink | SU-MIMO | Single User MIMO |
| SA | Standalone operation mode | SDNF | Structured Data Storage Network Function | SUL | Supplementary Uplink |
| SAE | System Architecture Evolution | SDP | Session Description Protocol | TA | Timing Advance, Tracking Area |
| SAP | Service Access Point | SSID | Service Set Identifier | TAC | Tracking Area Code |
| SAPD | Service Access Point Descriptor | SS/PBCH Block | SSBRI SS/PBCH Block Resource Indicator, Synchronization Signal Block Resource Indicator | TAG | Timing Advance Group |
| SLA | Service Level Agreement | | | | |
| SM | Session Management | SSC | Session and Service Continuity | TAI | Tracking Area Identity |
| SMF | Session Management Function | SS-RSRP | Synchronization Signal based Reference Signal Received Power | TAU | Tracking Area Update |
| SMS | Short Message Service | SS-RSRQ | Synchronization Signal based Reference Signal Received Quality | TB | Transport Block |
| SMSF | SMS Function | SS-SINR | Synchronization Signal based Signal to Noise and Interference Ratio | TBS | Transport Block Size |
| SMTC | SSB-based Measurement Timing Configuration | SSS | Secondary Synchronization Signal | TBD | To Be Defined |
| SN | Secondary Node, Sequence Number | SSSG | Search Space Set Group | TCI | Transmission Configuration Indicator |
| SoC | System on Chip | SSSIF | Search Space Set Indicator Fuction | TCP | Transmission Communication Protocol |
| SON | Self-Organizing Network | SST | Slice/Service Types | TDD | Time Division Duplex |
| SpCell | Special Cell | UDM | Unified Data Management | TDM | Time Division Multiplexing |
| SP-CSI-RNTI | Semi-Persistent CSI RNTI | UDP | User Datagram Protocol | TDMA | Time Division Multiple Access |
| SPS | Semi-Persistent Scheduling | UDSF | Unstructured Data Storage Network Function | TE | Terminal Equipment |
| SQN | Sequence number | UICC | Universal Integrated Circuit Card | TEID | Tunnel End Point Identifier |
| SR | Scheduling Request | UL | Uplink | TFT | Traffic Flow Template |
| SRB | Signalling Radio Bearer | UM | Unacknowledged Mode | UTRAN | Universal Terrestrial Radio Access Network |
| SRS | Sounding Reference Signal | UML | Unified Modelling Language | UwPTS | Uplink Pilot Time Slot |
| SS | Synchronization Signal | UMTS | Universal Mobile Telecommunications System | V2I | Vehicle-to-Infrastruction |
| SSB | Synchronization Signal Block | UP | User Plane | V2P | Vehicle-to-Pedestrian |
| TMSI | Temporary Mobile Subscriber Identity | UPF | User Plane Function | V2V | Vehicle-to-Vehicle |
| TNL | Transport Network Layer | URI | Uniform Resource Identifier | V2X | Vehicle-to-everything |
| TPC | Transmit Power Control | URL | Uniform Resource Locator | VIM | Virtualized Infrastructure Manager |
| TPMI | Transmitted Precoding Matrix Indicator | URLLC | Ultra-Reliable and Low Latency | VL | Virtual Link, |
| TR | Technical Report | USB | Universal Serial Bus | Virtual LAN, VLAN | Virtual Local Area Network |
| TRP, TRxP | Transmission Reception Point | USIM | Universal Subscriber Identity Module | VM | Virtual Machine |
| TRS | Tracking Reference Signal | USS | UE-specific search space | VNF | Virtualized Network Function |
| TRx | Transceiver | UTRA | UMTS Terrestrial Radio Access | VNFFG | VNF Forwarding Graph |
| TS | Technical Specifications, Technical Standard | | | VNFFGD | VNF Forwarding Graph Descriptor |
| TTI | Transmission Time Interval | | | VNFMVNF | Manager |
| Tx | Transmission, Transmitting, Transmitter | | | VoIP | Voice-over-IP, Voice-over- Internet Protocol |
| U-RNTI | UTRAN Radio Network Temporary Identity | | | VPLMN | Visited Public Land Mobile Network |
| UART | Universal Asynchronous Receiver and Transmitter | | | | |
| UCI | Uplink Control Information | | | | |
| UE | User Equipment | | | | |
| VPN | Virtual Private Network | | | | |
| VRB | Virtual Resource Block | | | | |
| WiMAX | Worldwide Interoperability for Microwave Access | | | | |
| WLAN | Wireless Local Area Network | | | | |
| WMAN | Wireless Metropolitan Area Network | | | | |
| WPAN | Wireless Personal Area Network | | | | |
| X2-C | X2-Control plane | | | | |
| X2-U | X2-User plane | | | | |
| XML | eXtensible Markup Language | | | | |
| XRES | EXpected user RESponse | | | | |
| XOR | eXclusive OR | | | | |
| ZC | Zadoff-Chu | | | | |
| ZP | Zero Power | | | | |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1. A method to be performed by a user equipment (UE), the method comprising:
transmitting, to a network entity of a cellular network, an indication of a UE policy container during an initial attach procedure; and
identifying, based on the transmission of the indication of the UE policy container, updated policy subscription information.

2. The method of claim 1, wherein the network entity is a packet data network (PDN) gateway control (PGW-C).

3. The method of claim 1, wherein the indication of the UE policy container is a protocol configuration option (PCO) or extended PCO (ePCO).

4. The method of claim 1, wherein the updated policy subscription information is received during an attach accept or packet data network (PDN) connectivity accept.

5. The method of claim 1, wherein the updated policy subscription information is based on information received by the network entity from a policy and charging function (PCF).

6. The method of claim 1, wherein the updated policy subscription information is based on information received by the network entity from a policy and charging rules function (PCRF).

7. A method to be performed by a packet data network (PDN) gateway control (PGW-C) entity of a cellular network, wherein the method comprises:
identifying, from a user equipment (UE) during an initial attach procedure, an indication of a UE policy container;
identifying, based on the UE policy container, updated policy subscription information; and
transmitting, to the UE, an indication of the updated policy subscription information.

8. The method of claim 7, wherein the indication of the UE policy container is a protocol configuration option (PCO).

9. The method of claim 7, wherein the indication of the UE policy container is an extended protocol configuration option (ePCO).

10. The method of claim 7, further comprising transmitting the indication of the updated policy subscription information in an attach accept transmission.

11. The method of claim 7, further comprising transmitting the indication of the updated policy subscription information in a packet data network (PDN) connectivity accept transmission.

12. The method of claim 7, wherein the updated policy subscription information is based on information received by the network entity from a policy and charging function (PCF).

13. The method of claim 7, wherein the updated policy subscription information is based on information received by the network entity from a policy and charging rules function (PCRF).

14. A method to be performed by a user equipment (UE), the method comprising:
identifying, from a network entity, a received indication of updated UE policy subscription information;
enacting the updated UE policy subscription information; and
transmitting, to the network entity, an indication of acknowledgement of the updated UE policy subscription information.

15. The method of claim 14, wherein the network entity is a packet data network (PDN) gateway control (PGW-C).

16. The method of claim 14, wherein the indication of the updated UE policy subscription information is received in a protocol configuration option (PCO).

17. The method of claim 14, wherein the indication of the updated UE policy subscription information is received in an extended protocol configuration option (ePCO).

18. The method of claim 14, wherein the updated UE policy subscription information is based on information received by the network entity from a policy and charging function (PCF).

19. The method of claim 14, wherein the updated UE policy subscription information is based on information received by the network entity from a policy and charging rules function (PCRF).

20. A method to be performed by a packet data network (PDN) gateway control (PGW-C) entity of a cellular network, wherein the method comprises:
identifying, from a network entity, a received indication of updated user equipment (UE) policy subscription information;
transmitting, to the UE, an indication of the updated UE policy subscription information;
identifying, in a message received from the UE, an acknowledgement of the updated UE policy subscription information; and
transmitting, to the network entity, an indication of the acknowledgement.

21. The method of claim 20, wherein the network entity is a policy and charging function (PCF).

22. The method of claim 20, wherein the network entity is a policy and charging rules function (PCRF).

23. The method of claim 20, wherein the indication of the updated UE policy subscription information is transmitted to the UE in a protocol configuration option (PCO).

24. The method of claim 20, wherein the indication of the updated UE policy subscription information is transmitted to the UE in an extended protocol configuration option (ePCO).
